(19) United States
(12) Patent Application Publication
(10) Pub. No.: US 2026/0260388 A1
(43) Pub. Date: Sep. 3, 2026

(54) Methods and Systems for Interactive Motion Data Processing

(71) Applicant: Proxima Beta Europe B.V., Amsterdam (NL)

(72) Inventors: Tobias Kleanthous, Amsterdam (NL); Antonio Martini, Amsterdam (NL)

(21) Appl. No.: 19/654,570

(22) Filed: Apr. 22, 2026

Related U.S. Application Data
(63) Continuation of application No. PCT/EP2023/081714, filed on Nov. 14, 2023.

(51) Int. Cl. G06T 9/00; G06T 13/20

(52) U.S. Cl. CPC G06T 9/002; G06T 13/20; G06T 2200/24

(57) ABSTRACT

Methods and systems for motion data processing using a neural network data coding model are provided. A method comprises: inputting source motion data into an input layer of an encoder; and processing the source motion data by at least one continuous representation generating layer of the encoder. The method further comprises inputting the compressed motion data into a decoder input layer of a decoder and directing the compressed motion data to a plurality of individual component neural networks of a decoding layer; decoding the compressed motion data by each one of the plurality of individual component neural networks to generate a plurality of individual decoded compressed motion data, and combining the plurality of individual decoded compressed motion data to generate decoded compressed motion data; decompressing the decoded compressed motion data by a decompressing layer of the decoder; and outputting the decoded decompressed motion data as output motion data.

### CROSS-REFERENCE TO RELATED APPLICATION

The application claims priority to PCT/EP2023/081714, filed Nov. 14, 2023, entitled “Methods and Systems for Interactive Motion Data Processing,” which is incorporated by reference in its entirety.

### FIELD

The present application relates to methods and systems for interactive processing of motion data, in particular for processing and reproducing or synthesizing motion data during user interaction.

### BACKGROUND

Currently, digital interactive applications strive to improve animations to have a more natural and realistic appearance. In recent years, several techniques, such as animation trees, parametric blending, motion graphs, etc., have been developed to increase the quality of animations. However, this has been at the expense of increased complexity of management of the assets and more heavy use of resources on video game playing devices, including a large increase in CPU computation time and memory usage.

Further techniques, such as motion matching, have emerged to attempt to solve the complexity of architecting animation systems related to the increased quality and has become widely adopted. However, these techniques maintain significant performance overhead issues, including computational and memory resource overheads. This limits their scalability in the context of modern video game performance profiles, and hence limits their applicability in various applications, such as video games across devices. Costs for combining and retrieving animations increase in CPU cost as more assets are required. Equally, as more assets are required, memory usage scales linearly with the amount of data required to increase quality.

This becomes a limiting factor to achieving high quality results due to constrained resources which are in contention with usage by other systems within a modern video game engine.

Developments have also been seen in the usage of machine learning and neural networks to synthesis animation from authored data at a high quality. One of such techniques is learned motion matching, which has addressed some of these challenges. However, while reducing memory requirements, it has been seen to result in increases in performance costs.

Machine learning and neural networks as currently known to motion data synthesis hence suffer from similar issues as those mentioned above in terms of performance that restrict their applicability in real time animation synthesis, such as gaming. As more data is required to be represented, the size and compute complexity of such neural networks can significantly increase to such an extent as to no longer be practical to use for applications involving a large numbers of interactive characters, for example as animated within a video game. As a consequence, few methods have successfully migrated from research to actual implementation within a video game engine.

### SUMMARY

It is an object of the application to address the above mentioned drawbacks and problems.

In particular, it is an object of the application to reduce the requirements regarding memory resources and the complexity of the computations, e.g., the CPU complexity, required for processing of animation data.

The methods and systems disclosed herein represent further developments building upon the foundations of motion matching and machine learning approaches to motion synthesis.

The methods and systems as disclosed herein have been observed to provide a significant reduction in memory usage related to compressing animation data and to reconstructing the animation data, as well as to the amount of computational complexity and resources related to decompressing the compressed animation data. This is facilitated through an improved distribution of the computing load, thereby also reducing the time required for animation data processing. Simultaneously, the compactness of the data that can be stored and the robustness of the accuracy of pose output has been improved.

Hence, the methods and systems of the present disclosure, wherein both the memory capacity required and the complexity of the computations involved in the processing and control of animation data have been reduced, enable a quicker and more diverse interaction between the user(s) on one hand and the computing system on the other hand, thereby allowing the user to control the computing system with a faster reaction time of the system and allowing the user to select and/or control the system to perform a variety of different actions.

This is achieved by the methods and systems as defined by the appended independent claims.

Various details and features of the application are claimed in dependent claims.

In a first aspect, a method of motion data processing using a neural network data coding model comprising an encoder and a decoder is provided. The method comprises: inputting motion data to an encoder input layer of the encoder; processing the source motion data by at least one continuous representation generating layer of the encoder, by transforming the source motion data into compressed motion data based on a predefined continuous function; outputting the compressed motion data by an encoder output layer of the encoder; inputting the compressed motion data into a decoder input layer of the decoder and directing the compressed motion data, through the decoder input layer, to a plurality of individual component neural networks of a decoding layer; and decoding the compressed motion data by each one of the plurality of individual component neural networks comprised in a decoding layer of the decoder part to generate a plurality of individual decoded compressed motion data. Each individual component neural network is connected to the decoder input layer. The method further comprises combining the plurality of individual decoded compressed motion data into one or more decoded compressed motion data; decompressing the decoded compressed motion data by a decompressing layer of the decoder; and outputting the decoded decompressed motion data as output motion data.

The neural network data coding model may be a model which performs the functions of encoding and subsequently decoding motion data, to generate a reconstructed motion from a received source motion data frame. It may be a neural network autoencoder model, or, for short, autoencoder. For example, it may be configured to process pose data included in the motion data, to encode and subsequently reconstruct the pose.

Motion data may comprise a plurality of motion data frames. Each motion data frame may comprise information about a pose, or state, of a virtual character or object, and features related to the character and its pose.

Motion data may comprise a collection of pose information data, including information associated with a single animation frame in three-dimensional space. In the examples of the present disclosure including the examples of both the claims and the specification (hereinafter referred to as “all examples of the present disclosure”), motion data is preferably configured as motion data frames, including pose data and associated feature data. After encoding, the motion data is stored in the encoded format <X,Z>, wherein X, Z may represent vector data <features, latent>. Features may include various properties that can be used to control motion of the virtual object, for example the present/future velocity and position or orientation, and/or different actions to be performed by the object.

Poses may be encoded offline, using the encoder, and stored in the encoded format <X,Z> which is <features, latent>, generated by the pose encoder. At run-time of an application using the encoded motion data, only the decoder may be employed to recreate poses starting from the encoded motion data <X, Z>.

The method may advantageously be used in interactive motion data processing, enabling interactive control of motions and/or other actions of the virtual character. For example, the motion trajectory can be controlled at least in part by the user through a user interface.

Hence, the encoded motion data, generally comprising a plurality of motion data frames, may be stored in vector format representing pose data and associated feature data. One or more of the motion data frames of the stored encoded motion data may be input to the decoder part, which processes the motion data frame and outputs reconstructed pose data. The motion data frame to be decoded may be selected based on user input control data. Furthermore, as will be discussed in more detail further on, the method may be applied for predicting future data frames. The prediction may be based on the features X, which may eventually be altered based on user input control data.

The method may be applied to various different applications using interactive control of motion data, e.g. for synthesizing future motion data frames, e.g. an animation clip, and/or for providing predictions or estimates as to a future motion data and/or pose data based on user input. To this end, as will be described later herein below, user input control data may be input to the data coding model for controlling or influencing a virtual character or object present in the motion data. Applications may include various educational, training, and/or simulation purposes, within a variety of fields. Examples may be found in health care, traffic control and/or safety, vehicle safety, entertainment, etc.

The method may for example be applied to pose reconstruction, through encoding and decoding of motion data including a pose of a virtual character or object. Herein, the term pose refers to the posture or physical state of a virtual character or object at a given point in time, e.g. within a virtual environment.

An animation data frame refers to a single sampled pose of the virtual character at one point in time in an animation.

Animation clips refer to sub-samples of animations showing character motion for different purposes in a virtual environment.

Motion matching refers to the selection of animation clips based on physical properties such as velocity, speed, position, orientation, etc., and features such as actions and timings.

The method may involve predicting a pose of the virtual character of object at a future point in time, based on the input control data.

The continuous representation generating layer transforms the input motion data, in particular the pose data, according to a predefined continuous function. The continuous function is selected to result in the temporal relationship between successive motion data frames being maintained, and to preserve the linear relationship and coherency between the original space, i.e., the input motion data frames, and the compressed space, also referred to as latent manifold, including the encoded motion data frames. The transformation according to the predefined continuous function ensures that the internal representation of the motion data, e.g., the latent data, is closely aligned with the source motion data, which was input into the encoder, while the internal representation of the motion data, e.g., the encoded motion data, is in a compact form enabling fast operation and processing by the other parts, e.g. layers, of the data coding model, as well as of other components, such as a neural network stepper model and a neural network projector model, which may be included in a system for processing motion data. Such system is provided with the second aspect of the present disclosure.

In the examples of the present disclosure including the examples of both the claims and the specification (hereinafter referred to as “all examples of the present disclosure”), the predefined continuous function may preferably be a Lipschitz continuous function, and the continuous representation generating layers may be referred to as Lipschitz continuous representation generating layers, or Lipschitz layers for short.

One or more continuous representation generating layers may be provided in the encoder.

The encoded and compressed motion data, e.g., the latent data, may be stored in a memory or storage space.

The input control data generally includes, or is at least partly generated based on, user input, e.g., to control or influence motion data in a virtual environment, for interactive control of a virtual character or other object in the virtual environment. When the input control data relates to the control of movements and/or changes in orientation of the virtual character or object, additional input control data, such as motion matching features, may be inputted to the data coding model.

In the example of game play, the input control data including parameters representing one or more physical properties such as speed, direction and/or positions of a virtual character and gameplay features such as actions and timings, included in interactive user control.

The decoding layer is provided as a layer comprising a plurality of individual component neural networks, e.g., not as one single neural network wherein each node is connected to each node in the previous and the subsequent layer. Thereby, a load distribution is realized, leading to less computational complexity. This also reduces the memory requirements. The individual component neural networks may be feedforward neural networks. The number of individual component neural networks processing the motion data frame may be selected based on the complexity of the computation, e.g., the complexity of the motion data. In some examples, the motion data frames may be decoded by two individual component neural networks.

In the examples of the present disclosure including the examples of both the claims and the specification (hereinafter referred to as “all examples of the present disclosure”), the decoding layer is configured as a sparse layer, preferably as a Sparse Mixture of Experts layer.

In the examples of the present disclosure including the examples of both the claims and the specification (hereinafter referred to as “all examples of the present disclosure”), the decompressing layer can be described as a linear layer having an activation function. The term linear layer refers to a layer wherein all nodes are connected to all nodes of the previous and subsequent layers. Decompression may be performed according to computation methods as known in the field of data encoding and decoding.

The predefined continuous function may advantageously be a Lipschitz continuous function. Configuring the one or more encoding layers to provide Lipschitz continuous representations of the input motion data has been seen to be particularly advantageous, and to provide improved characteristics of the encoding. The temporal relationship between successive data frames is maintained, and the linear relationship and coherency between the original space and the compressed space, also referred to as latent manifold, is preserved. With the Lipschitz technique applied to the encoder part, an improved distribution of motion data frames in the latent manifold has been observed. These effects enable the use of a sparse layer, such as a Sparse Mixture of Experts, SMoE, layer as the decoding layer of decoder part.

A function ƒ is defined as Lipschitz continuous when the constant c satisfies:

$$( f ( x ) - f ( y ) ) \leq c \cdot ( x - y )$$

The Lipschitz continuous function may be effectively learnt by the neural network model. The learning of the constant c is induced to satisfy the above condition

Each of the continuous representation generating layers may be configured as a Lipschitz continuous representation layer with an associated learnable Lipschitz constant c, the Lipschitz constant c associated with a weight normalization to be used by the Lipschitz continuous representation layer.

The motion data may be transformed by a plurality of successively connected continuous representation generating layers.

The Lipschitz continuous representation layers used in the encoder part provides a Lipschitz continuous representation of the animation data in the data coding model. In other words, the compressed, or latent, form of the animation data is expressed via a Lipschitz continuous neural network.

This has been observed to be particularly advantageous in ensuring that the internal representation of the motion data, e.g., the latent data, is closely aligned with the source motion data, which was input into the encoder of the data coding model, while the internal representation of the motion data is in a compact form enabling fast operation and processing by the other parts, e.g. layers, of the data coding model, as well as of other components, such as a stepper model and a projector model, which may be included in a system for interactive processing of motion data according to the second aspect of the present disclosure. The Lipschitz continuity ensures that a relationship between animations in the original motion data is preserved in the compressed space, and subsequently in the reconstructed motion data. This has been observed to result in a reconstruction quality when decompressing the data to runtime motion data decoding and synthesizing of motion data frames, which is comparable with the source motion data. In particular, the method has been observed to reconstruct pose data, and predict future pose data, with high accuracy.

Using the data coding method as described herein, in particular through the Lipschitz continuous representation of the motion data, the reconstruction quality has been observed to exceed that of currently known methods. The temporal properties of the motion data have been observed to be preserved in a way that has not been seen with conventional methods, in which the Lipschitz representation was not applied.

Through the inclusion of the Lipschitz representation in the encoder part of the data coding model, a smooth progression of poses represented by the motion data can be achieved in the latent manifold, with a good correlation between different samples of motion matching features related to poses in subsequent motion data frames.

The decoding layer may advantageously be configured as a Sparse Mixture of Experts, SMoE layer. The SMoE layer comprises a plurality of individual component neural networks, of which only a subset is activated for processing a compressed motion data.

The SMoE layer can be thought of as one large neural network layer having been replaced by a plurality of smaller neural network layers. Thereby, the number of neural network node connections in the layer is significantly reduced. Hence, the computational complexity and also the requirements as to memory capacity and the memory load are reduced significantly. Instead of inputting the compressed motion data into the large neural network layer and processing it through the large neural network layer, a subset of the smaller neural network layers is selected for processing the compressed motion data. Thereby, the processing time can be greatly reduced. Also, a higher accuracy has been observed. Furthermore, as the processing is distributed over a subset of the individual neural network components, also referred to as experts, reducing the complexity of computation, interactive motion data processing may be performed on a larger number of virtual characters.

With the Sparse Mixture of Experts, a large neural network layer is replaced by a plurality of smaller neural network layers, thereby reducing the number of neural network node connections in the layer. With the SMoE architecture, the memory capacity required for storing weights of the neural network model is significantly reduced, and the CPU complexity is significantly reduced. At the same time, the time required for motion data processing is reduced, and the accuracy of the resulting output motion data, i.e., the reconstructed motion data, may be increased.

In an example, when the decoding layer is configured as an SMoE layer, the following architecture may be applied in the decoder.

The decoder input layer is a gating layer, the method further comprising: inputting the compressed motion data into the gating layer; calculating, by the gating layer, a probability of activation for each one of the individual component neural networks; selecting a subset of the plurality of individual component neural networks corresponding to a preset number of individual component neural networks having highest probability of activation among the individual component neural networks; gating the compressed motion data to the individual component neural networks of the subset; and calculating a weighted sum of the outputs of the individual component neural networks of the subset and providing the weighted sum as output of the SMoE layer, wherein the weighted sum represents a sum of the output of each the individual component neural network of the subset weighted by their associated normalized gate values.

The preset number of individual component neural networks is a trade-off between the size of the database required for processing, i.e., the amount of motion data to be processed by the data coding model, the computation load and the desired accuracy of the reconstructed, or output, motion data. In some examples, the preset number of the individual component neural networks in the subset is two. However, other numbers are also possible.

Implementing the Sparse Mixture of Experts neural network architecture in the method for interactive motion data processing has been observed greatly reduce the size of individual components and connections in the neural network data coding model, as compared to conventional architectures not using an SMoE architecture, while retaining the quality, or at least providing a substantially comparable quality.

Thereby, the computing complexity, or CPU complexity, as well as memory usage can be vastly reduced. A linear or even quadratic performance increase relating to memory usage, as compared to conventional methods in which the SMoE technique is not applied, has been observed.

Applying the Sparse Mixture of Experts architecture to the neural network data coding model, or autoencoder, as disclosed herein, has been observed to improve both the volume of data that can be represented using the method, whilst also reducing the memory and CPU requirements compared to both motion matching and neural network-based motion synthesis methods.

In some examples, the method may comprise decoding the data through a plurality of SMoE layers in the decoder part. While one single SMoE layer has been observed to be sufficient, e.g. as it has been observed to realize reconstructed motion data meeting the preset quality level, the SMoE architecture may comprise a stack of SMoE layers. The number of layers chosen may be dependent on the complexity of the functions to be executed.

The method further advantageously comprises storing the compressed motion data output by the encoder output layer as stored compressed motion data, the compressed motion data comprising a plurality of compressed motion data frames; and further comprises: receiving input control data; selecting a compressed motion data frame from the stored compressed motion data based on the input control data; and inputting the selected compressed motion data frame into the decoder input layer, and subsequently performing the steps on directing, decoding, decompressing and outputting on the selected motion data frame.

The input control data may comprise user input control data and information of a virtual object controlled by the user, wherein the input control data may comprise user input control data and information of a virtual object controlled by the user, the user input control data comprising information relating to at least one of an action to be performed on or by the virtual object, a movement to be performed by the virtual object, and a change in orientation to be performed by the virtual object.

The input control data may comprise user input control data and information of a virtual object controlled by the user, the user input control data comprising information relating to at least one of an action to be performed on or by the virtual object, a movement to be performed by the virtual object, and a change in orientation to be performed by the virtual object.

According to the method, the motion data frame, e.g., the pose and associated features X, may be sought which best matches the input control data.

A future motion data frame representing the motion data at a future point in time may be predicted based on the selected compressed motion data and the user input control data, and inputting the future motion data frame to the decoder input layer.

The compressed motion data or the future motion data frame may be concatenated with additional control data and the concatenated data input into the decoder input layer.

Through the linear relationship between successive motion data frames being preserved with the neural network models described herein, future frames of motion data have been seen to be predictable for a much greater period of time, further contributing to the reduction in the requirements to reset sampling to a known place in this space. This then reduces the CPU cost of other components used in the method.

The different steps and features described above in respect of the first aspect may be combined with one another, in various different ways, as will be understood by a person skilled in the art.

The method according to the first aspect may be performed by the system according to the second aspect, described herein below.

According to a second aspect, a system for motion data processing is provided, the system comprising a neural network data coding model for processing motion data, the neural network data coding model comprising an encoding part and a decoding part, the system further comprising: a processor configured to: control processing of the motion data by the neural network data coding model; the neural network data coding model comprising: the encoder part, comprising a plurality of successively connected encoder layers, the encoder layers comprising: an encoder input layer configured for receiving the source motion data; at least one continuous representation generating layer configured to transform the source motion data into compressed motion data based on a predefined continuous function; and an encoder output layer for outputting the compressed motion data; the decoder part, comprising a plurality of successively connected decoder layers, the decoder layers comprising: a decoder input layer for receiving the compressed motion data; a decoding layer configured to decode the compressed motion data into decoded compressed motion data, the decoding layer comprising a plurality of individual component neural networks each connected to the decoder input layer to receive and process the compressed motion data, and to provide as output decoded compressed motion data; and a decompressing layer configured to decompress the decoded compressed motion data, and an output layer configured to output the decompressed decoded motion data as output motion data.

The system according to the second aspect may be configured to perform the method according to the first aspect, as described herein above. The system of the second aspect may be configured to perform the method according to any combination of the steps and features described with respect to the first aspect.

The features and terminology used relating to the second aspect have the same definition, meaning, function and effects as set out herein above in respect of the first aspect. These are therefore not repeated herein below.

The at least one continuous representation generating layer may advantageously be configured as a Lipschitz continuous representation layer, configured to transform the source motion data using a Lipschitz continuous transformation, to form a Lipschitz continuous representation of the motion data.

Each of the at least one Lipschitz continuous representation layers may be configured as a linear layer with an associated learnable Lipschitz constant c for determining a weight normalization to be used by the Lipschitz continuous representation layer.

A plurality of the Lipschitz continuous representation layers may be provided.

The decoding layer may advantageously be configured as a Sparse Mixture of Experts, SMoE, layer comprising a plurality of individual component neural networks.

When the decoding layer is configured as an SMoE layer, the decoder input layer may be a gating layer, and each one of the plurality of individual component neural networks connected to the gating layer for receiving the compressed motion data from the gating layer, and to the output layer.

When such SMoE architecture is applied, the processor may be configured to control the decoder part to: input the compressed motion data into the gating layer; calculating, by the gating layer, a probability of activation for each one of the individual component neural networks; selecting a subset of the plurality of individual component neural networks corresponding to a preset number of individual component neural networks having highest probability of activation among the individual component neural networks and processing the compressed motion data by each one of the individual component neural networks of the subset; calculating a weighted sum of the outputs of the individual component neural networks of the subset and providing a weighted sum as output of the SMoE layer, wherein the output is represented by the weighted sum of the output of each the individual component neural network of the subset weighted by their associated normalized gate values.

The system may further comprise an interface for receiving input control data and storage means, such as a memory, for storing the compressed motion data output by the encoder output layer, the processor further configured to select a compressed motion data frame from the stored compressed motion data and input the selected compressed motion data frame into the decoder input layer, and subsequently control the steps on directing, decoding, decompressing and outputting to be performed based on the selected motion data frame.

The input control data may comprise user input control data and information of a virtual object controlled by the user, the user input control data comprising information relating to at least one of an action to be performed on or by the virtual object, a movement to be performed by the virtual object, and a change in orientation to be performed by the virtual object.

The processor may be further configured to receive a predicted future motion data frame representing the motion data at a future point in time and additional input control data.

The processor may be further configured to concatenate the compressed motion data or the future motion data with the additional control data and inputting the concatenated data into the decoder input layer.

The system may further comprise a neural network predictive model configured to predict the future motion data frame at a future point in time based on the encoded compressed motion data and the user control input data. The neural network predictive model further preferably may be configured to generate the additional input control data.

The above described steps and features may be combined with one another, in various different ways, as will be understood by a person skilled in the art.

According to a third aspect, a method of generating a neural network data coding model for processing motion data is provided, the data coding model comprising an encoder part and a decoder part, the method comprising the steps of: initializing the encoder part by successively connecting a plurality of encoder layers, the encoder layers comprising: an encoder input layer for receiving source motion data; at least one continuous representation generating layer configured to transform the source motion data into compressed motion data based on a predefined continuous function; an encoder output layer for outputting the compressed motion data; initializing the decoder part by successively connecting a plurality of decoder layers, the decoder layers comprising: a decoder input layer for receiving the compressed motion data; a decoding layer configured to decode the compressed motion data into decoded compressed motion data, the decoding layer comprising a plurality of individual component neural networks each connected to the decoder input layer to receive the compressed motion data providing as output decoded compressed motion data; and a decompressing layer configured to decompress the decoded compressed motion data, and an output layer configured to output the decompressed decoded motion data as output motion data; training the neural network data coding model until a matching between source motion data input into the data coding model and a resulting output motion data, representing the source motion data as processed by the data coding model, meets a preset quality level.

The features and terminology used in relation to the third aspect have the same definition, meaning, function and effects as set out herein above in respect of the first and second aspects. These are therefore not repeated herein below.

The method according to the third aspect may be used to generate the neural network data coding model used in the method according to the first aspect and/or as comprised in and used by the system according to the second aspect.

The neural network data coding model comprised in the system according to the second aspect may be generated using the method according to the third aspect.

The method according to the third aspect may use, comprise or include any of the features, steps and/or details described herein above in respect of the first and second aspects.

The method may further comprise configuring the at least one continuous representation generating layer is configured as a Lipschitz continuous representation layer, configured to transform the source motion data using a Lipschitz continuous transformation, to form a Lipschitz continuous representation of the motion data.

The method may further comprise forming each of the Lipschitz continuous representation layer by constructing a linear layer with an associated learnable Lipschitz constant c, and using the Lipschitz constant c for determining a weight normalization to be used by the Lipschitz continuous representation layer.

The method may further comprise configuring the decoding layer as a Sparse Mixture of Experts, SMoE, layer; and wherein the decoder input layer is a gating layer, the method further comprising constructing the SMoE layer by forming the plurality of individual component neural networks each connected to the gating layer for receiving the compressed motion data from the gating layer the method further comprising: inputting the compressed motion data into the gating layer, calculating, by the gating layer, a probability of activation for each one of the individual component neural networks; selecting a subset of the plurality of individual component neural networks corresponding to a preset number of individual component neural networks having highest probability of activation among the individual component neural networks; calculating a weighted sum of the outputs of the individual component neural networks of the subset and providing a weighted sum as output of the SMoE layer, wherein the output is represented by the weighted sum of the output of each the individual component neural network of the subset weighted by their associated normalized gate values.

The training may comprise: inputting source motion data into the encoder input layer; processing the motion data by the data coding model; receiving as output, from the output decoder layer, output motion data representing decompressed decoded motion data; comparing the output motion data with the source motion data and assessing a matching degree between the output motion data and the source motion data in order to calculate a quality level of the output motion data; and the method comprising re-iterating the training until the quality level of the output data meets a preset quality level.

The training may be performed using methods well known in the field of neural networks. With the different iterations, the internal “weights” of the layers of individual layers in the neural network models may be updated using a standard deep learning process involving backpropagation based on the gradients calculated from the “losses”. The methods for updating the weights, and the criteria for updating these may be set according to principles known in the art, e.g. as known in the theory of backpropagation. These losses numerically state how well or badly a particular iteration performed or a subset of the entire source training data.

The training of the neural network model may be run, or re-iterated for a minimum number of steps, which may be set based on testing to iterate long enough to ensure that the positions of individual features of a virtual character or object present in motion data frames, for example bones in a character's pose, have a mean positional error that is less than a predetermined value. For example, in applications involving virtual characters, the predetermined value may be set as to when the bones in the character's pose are reconstructed with an accuracy of 1 cm or less. This predetermined value may represent a primary metric to express final quality for an end user.

One or more of the training steps, such as calculations and/or evaluation of the matching between the source motion data and the motion data output by the neural network data coding model during training, i.e., the reconstructed motion data, may be performed by the same or by a different processor as the processor on which the encoding and/or decoding steps are performed.

The training may further comprise training the neural network data coding model in pairs of temporally consecutive motion data frames.

When training the autoencoder in pairs of temporally consecutive poses, an additional loss for minimizing the difference between local space and model space velocities in the training data and predictions can be calculated using various known methods. In one example, it may be expressed as:

$$VelocityLoss ( P , \hat{P} ) = \frac{1}{J} {\sum }_{j = 1}^{T} ( \frac{{P}_{1} - {P}_{0}}{δ t} - \frac{\hat{{P}_{1}} - \hat{{P}_{0}}}{δ t} )$$

Herein, P₁, P₀ represent two original motion data frames, or poses, of the source motion data at times t0 and t1. \hat{P}₀, \hat{P}₁ represent the corresponding motion data frames in the output data, i.e., the output of the neural network's reconstruction of the motion data frames, or pose. From this, the velocity observed in the original motion data for a time “t” between t0 and t1 can be calculated. The idea is to minimize the difference between the original motion data and the reconstructed output from the neural network model. The intuition is that encouraging the neural network to learn to produce a similar velocity on parts of the pose to the original data will produce a smoother reconstruction of motion data that better maps to the source motion data.

Thereby, an overall velocity with the predictions of future frames can be evaluated.

The above described steps and features may be combined with one another, in various different ways, as will be understood by a person skilled in the art.

In a fourth aspect, a non-transitory computer-readable medium is provided, storing instructions which, when executed by a processor, cause the processor to execute the method of any one of claims 1-8 or claims 17-20.

As can be understood from the above, advantageously, the neural network data coding model, also referred to as autoencoder, may be realized through combining encoding the motion data through neural network modeling techniques based on Lipschitz continuity and decoding using a Sparse Mixture of Experts approach.

In summary, the methods and systems according to the current disclosure have been observed to significantly reduce the amount of CPU operation complexity and required memory space, thereby improving performance in terms of both CPU operation and memory requirements. User-system interaction at high speed and accuracy have been enabled, including dynamic character control of high-quality animation synthesis, for example video game applications involving multiple players at different stations and associated large number of virtual characters.

Further, a predictive neural network model, e.g., system for processing animation data, using the neural network autoencoder disclosed herein has been observed to be better able to learn, and predict, during interactive motion data processing, future frames of motion data represented in a virtual environment, with a higher quality, than currently known methods.

### BRIEF DESCRIPTION OF THE DRAWINGS

Further features and advantages of the application will become apparent from the description of the application by way of non-limiting and non-exclusive examples. These examples are not to be construed as limiting the scope of protection. The person skilled in the art will realize that other alternatives and equivalent examples of the application can be conceived and reduced to practice without departing from the scope of the present application. Embodiments of the application will be described with reference to the figures of the accompanying drawings, in which like or same reference symbols denote like, same or corresponding parts, and in which:

FIG. 1 shows a flow chart illustrating a method of motion data processing, according to examples of the present application;

FIG. 2 schematically illustrates a neural network data coding model, which may be used in the method of FIG. 1, according to examples of the present application;

FIG. 3 schematically illustrates a section of a decoder part of the data coding model of FIG. 2, according to examples of the present application.

FIG. 4 shows a flow chart illustrating a method of motion data processing, according to examples of the present application;

FIG. 5 schematically illustrates a neural network data coding model, which may be used in the method of FIG. 4, according to examples of the present application;

FIG. 6 schematically illustrates a neural network architecture which may be used in a section of a decoder part of the data coding model of FIG. 5, according to examples of the present application;

FIG. 7 shows a flowchart representing a method performed by s Sparse Mixture of Experts architecture according to examples of the present disclosure;

FIG. 8 schematically illustrates a system for motion data processing according to examples of the present disclosure;

FIG. 9 illustrates a method of motion data processing according to examples of the present disclosure;

FIG. 10 shows a flowchart representing a method of generating a neural network data coding model according to examples of the present disclosure;

FIG. 11A, 11B schematically illustrates an advantageous effect of motion data encoding using Lipschitz transformations, according to examples of the present disclosure;

FIG. 12A, 12B illustrated improved accuracy of reconstructed animation data obtained using methods according to examples of the present disclosure.

### DETAILED DESCRIPTION

In the description below, various example examples of the aspects disclosed herein above are described. The definitions, explanations, and details as disclosed in the Summary section above apply analogously, and are therefore not necessarily repeated.

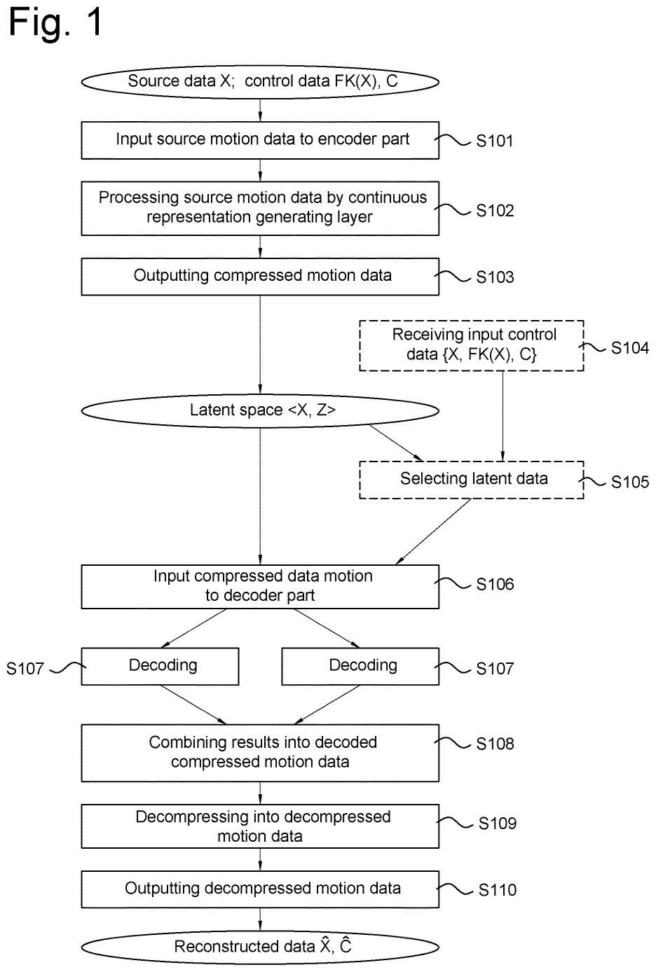

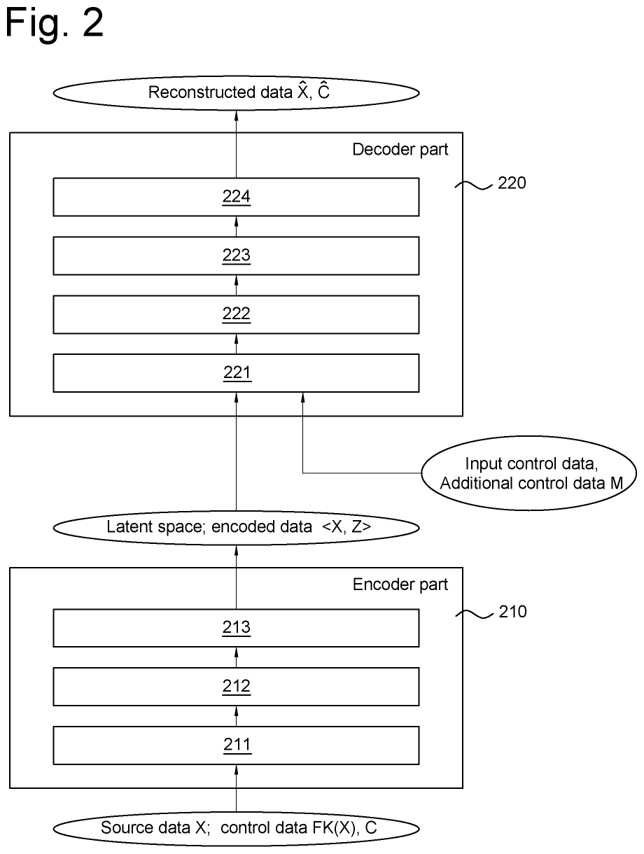

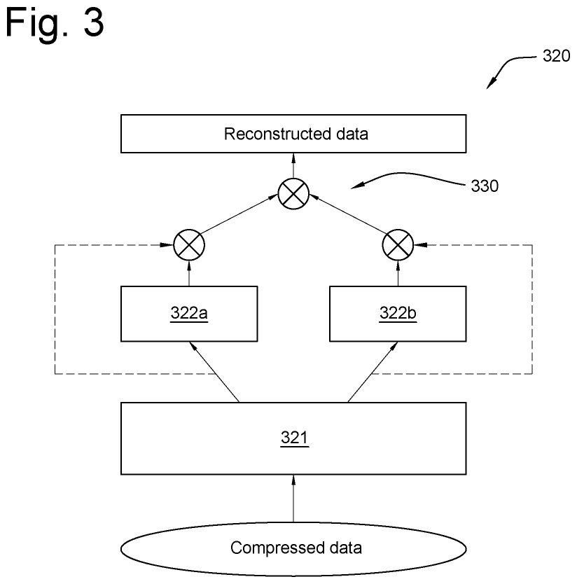

FIG. 1 shows a flowchart illustrating a method of motion data processing using a neural network data coding model, according to a nonlimiting example. A neural network data coding model, corresponding to the method illustrated in FIG. 1 is schematically illustrated in FIG. 2. A detail of the decoder part used in FIG. 2 is schematically shown in FIG. 3.

The method as schematically shown in FIG. 1 comprises the steps of:

S101: inputting the source motion data into an encoder input layer of the encoder part of the data coding model.

The method of motion data processing may be performed while an application is running, for example an interactive application displaying motion data, for example comprising a pose and associated data, or a collection of pose information data, referred to as currently displayed animation data, on and/or by one or more display devices. A user may input user control data, for controlling one or more actions relating to an object or virtual character represented in the currently displayed animation data.

S102: processing the source animation data by at least one continuous representation generating layer of the encoder part. The continuous representation generating layer transforms the input animation data into compressed animation data based on a predefined continuous function. Through the continuous function, the layer transforms the source animation data into compressed animation data, that is, into animation data in the latent space.

The transformation may be performed by one single layer or through successive transformation through a plurality of continuous representation generating layers, each layer associated with a different continuous function. The one or more continuous representation generating layer may be linear layers, each combined or provided with an activation function, preferably a GELU activation function or similar, which are known in the art. Linear layers may also be referred to as fully connected layers. The activation functions may be selected among activation functions known in the field. The last continuous representation generating layer may be a purely linear layer, and described as a linear layer having an identity activation function. The nature of the final output determines what kind of activations are used for specific groups of neurons in the final layer. Preferably, sigmoid activations are used in certain neurons of the last layer where probabilities in the 0-1 range are expected, whereas no activation is applied in the last layer when the output is expect to be in the domain of the real numbers. For example, if a neuron needs to output a probability, the activation may be a sigmoid, if the output need to lie in the [0,+infinite] interval, then the activation may be a GELU/ReLU or similar. If the expected output is over the full real numbers there will be no activation, or, alternatively expressed, an identity activation function.

In some examples of the present disclosure, the predefined continuous function may preferably be a Lipschitz continuous function. The one or more continuous representation generating layers may than be referred to as Lipschitz continuous representation generating layers, or Lipschitz layers.

S103: outputting the compressed motion data by an encoder output layer of the encoder part. Herein, the compressed and encoded motion data, resulting from the encoding, may also be referred to as latent data, and forms part of a latent space. As described further herein above, the motion data may typically comprise data relating to a pose or character, Z, and related features, X, and may be stored in the format <X, Z>.

Encoding may be performed on a plurality of motion data frames, each generally relating to a character pose and related features. The motion data may hence comprise a collection of pose information data, wherein each pose information data may comprise information associated with a single animation frame in three dimensional space. These may also be referred to as animation frames, or animation data. The encoded data for all frames may be stored in a memory and/or database. In this way, motion data may be encoded offline, prior to or independent of running an application, using the encoder part of the data coding model. The encoded motion data is stored in the encoded format <X,Z>, which represents <features, latent>.

Steps S101 to S103 may be referred to as encoding steps.

In some examples, the method is an interactive method, and comprises also steps S104 and S105.

S104: receiving input control data. As discussed above, this may include user input data for interactively processing motion data. The input control data generally includes, or is at least partly generated based on, user input, for example to control or influence motion data in a virtual environment, for interactive control of a virtual character or other object in the virtual environment by a user of the system. For example, the user may input control data indicating one or more of: an action to be performed by the virtual character, a direction in which he wants a virtual character to move, a movement to be performed by the virtual character, a direction of movement of the virtual character, etc.

S105: selecting a motion data frame from the encoded motion data in the latent space, based on the input control data. During runtime of the application, poses may be reconstructed, the decoder part, starting from features and pose latent data, generated by the encoder part of the model. The features X preferably relate to properties that can be used to control motion, for example the present/future velocity and position of the virtual character or object to be controlled within a virtual environment. This trajectory can be controlled, at least in part, by the user executing the application. The user may input the control data through a user interface, for example a joypad, console, etc., as are known in the art. Hence, a current feature vector X may be affected, e.g., altered, by user input.

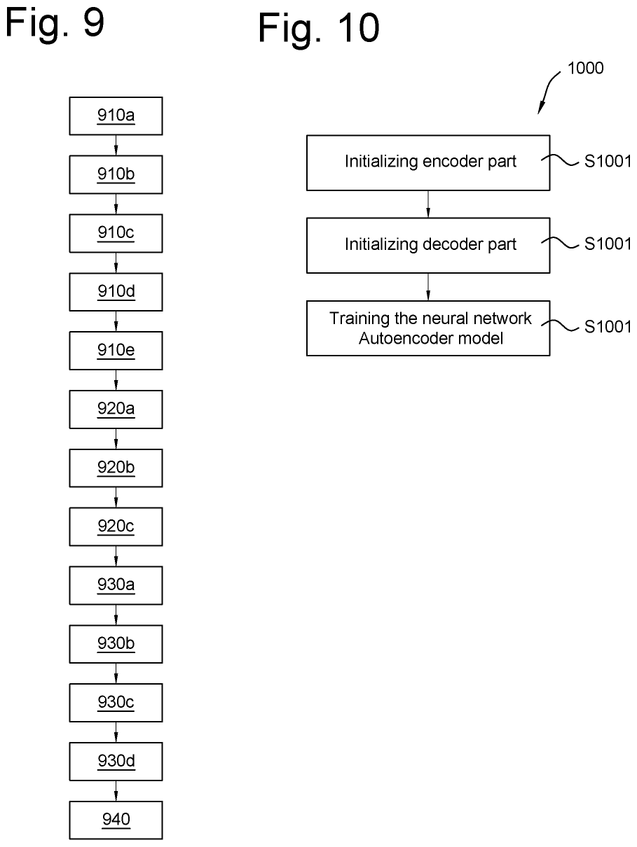

When there is no user input, motion data output by the encoder output layer may be passed on, directly or indirectly after having been stored in and retrieved from a memory, to the decoder input layer for decoding. In an example wherein an application showing and substantially continuously updating data based on motion data, such as animation data, is running, the system may automatically estimate the best features X and latent for a next motion data frame, or animation frame, using a projector model, and a stepper model may apply forward kinematics to the data of the selected motion data frame, and inputting this into the decoder part. This will be described in further detail further with reference to FIGS. 8 and 9 herein below.

S106: inputting the compressed motion data into a decoder input layer of the decoder part of the data coding model, and directing it, through the decoder input layer, to a decoding layer comprising plurality of individual component neural networks.

The decoding layer may hence also be referred to as a non-linear, or not fully, connected layer. In all examples disclosed herein, the decoding layer may be a sparse layer. In all examples, the decoding layer may preferably be a Sparse Mixture of Experts layer.

S107: decoding the compressed motion data by each one of the plurality of individual component neural networks, each individual component neural network thereby generating individual decoded compressed motion data. Each individual component neural network is connected to the decoder input layer.

S108: The individual decoded compressed motion data generated by each individual component neural network are combined into decoded compressed motion data. Whereas FIG. 1 suggests that the motion data is processed by two individual component neural networks, another number representing a plurality of individual component neural networks may be used, depending on the complexity of the motion data to be decoded.

S109: decompressing the decoded compressed motion data by a decompressing layer of the decoder part. Decompression might be performed by one single decompressing layer, or successively through a plurality of successive decompressing layers. The decompressing layers are preferably linear layers provided with an activation function, which may be similar as the activation functions described herein above with respect to the continuous representation generating layers.

S110: outputting the decoded decompressed motion data as output motion data. The output motion data may also be referred to as reconstructed motion data, or reconstructed pose data.

The steps S106 to S110 may be referred to as decoding steps, or a decoding method.

Hence, with this method, a source animation data frame may be input to the encoder part, encoded into latent form, and subsequently decoded into a reconstructed animation data frame. For example, an original pose data may be encoded to latent pose data, and subsequently decoded, to obtain reconstructed pose data. As described, the latent data may comprise plurality of animation data frames, e.g., a plurality of pose data relating to different poses. Based on input control data, such as user control data relating to an intended motion and/or action to be performed on the pose, one of the plurality of latent animation data frames may be selected for being encoded. The animation, or motion data, retrieved from the latent space to be input to the decoder part, may be concatenated, or combined, with additional data.

FIG. 2 schematically illustrates a neural network data coding model 200, according to an example of the application, which may be applied when performing the method of FIG. 1. The data coding model 200, which may also be referred to as autoencoder, comprises an encoder part 210 and a decoder part 220. The encoder part 210 may be configured to perform steps S103 to S105, and the decoder part may be configured to perform steps S106 to S110, as described with reference to FIG. 1.

The encoder part and the decoder part of the data coding model comprises, respectively, at least, the following layers.

The encoder part 210 comprises at least the following layers.

An encoder input layer 211 configured for receiving the source motion data. The motion data may comprise pose data, e.g., relating to a pose or state of a virtual character or object, and feature data relating to the pose data.

A continuous representation generating layer 212 configured to transform the source motion data into compressed motion data based on a predefined continuous function. The continuous representation generating layer transform the input motion data according to a predefined continuous function. Herein, at least the pose data may be subject to the transformation.

While in the illustration of FIG. 2, one single continuous representation generating layer is shown, this is merely an example. A plurality of successively connected continuous representation layers may be included.

An encoder output layer 213 for outputting the compressed motion data. The compressed motion data is outputted to the latent space, and may be referred to as latent motion data. The latent motion data comprises the pose data and associated feature data.

The decoder part 220 comprises at least the following layers.

A decoder input layer 221 for receiving the compressed motion data. In particular, compressed motion data frames may be input to the decoder, comprising compressed pose data and associated feature data.

In some examples, as discussed in the present disclosure, the compressed motion data may be concatenated with additional input control data, for example motion matching features M, before, upon, or after being input to the decoder input layer. Alternatively, a predicted future motion data frame may be predicted based on the compressed motion data and, optionally, concatenated with additional input control data.

The motion matching features may typically be derived from the source motion data. The motion matching features may include positions of a number of features or parts of the virtual character or object to be controlled, e.g., whose movements, orientation and/or other action is to be influenced by the user input data. Also, control parameters can be included, controlling how the character or object may perform an action at a future point in time if not being interrupted or influenced by user control data. In an example of a virtual character, the motion matching features may include positions of a select number of bones (such as feet) and their velocities in model or forward kinematic space.

A decoding layer 222 configured to decode the compressed motion data into decoded compressed motion data, the decoding layer comprising a plurality of individual component neural networks each connected to the decoder input layer to receive and process the compressed motion data, and to provide as output decoded compressed motion data. The decoding layer is illustrated schematically in FIG. 3.

A decompressing layer 223 configured to decompress the decoded compressed motion data. Although in the figure only one decompressing layer 223 is shown, a plurality of successively connected decompressing layers 223 may be provided. These are preferably configured as linear layers plus an activation function, as described herein above.

An output layer 224 configured to output the decompressed decoded motion data as output motion data.

In the example of FIG. 2, the decoding layer 222 may be implemented using an architecture as illustrated in FIG. 3.

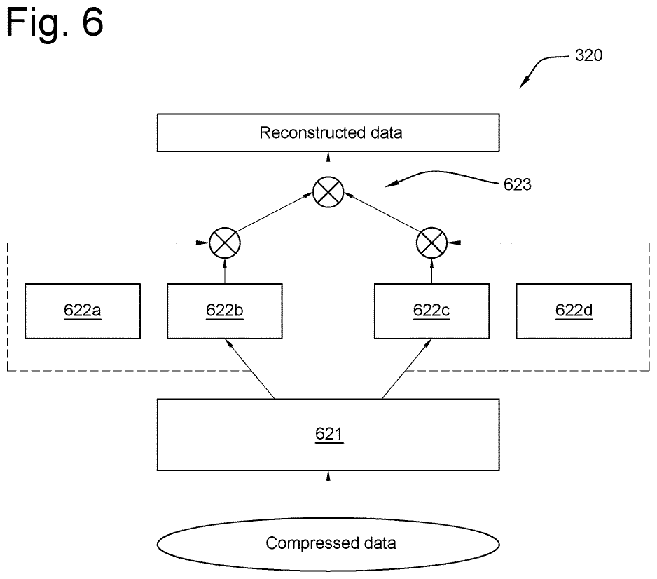

As illustrated schematically in FIG. 3, the decoding layer 222 is provided as a layer 322 comprising a plurality of individual component neural networks 322a, 322b, configured to process the compressed motion data input to the decoder part through the decoder input layer 321. In summation layer 330, the output from each one of the individual component neural networks 322a, 322b is combined, for example in the form of a weighted sum as described with reference to summation layer 623 of FIG. 6 further herein below.

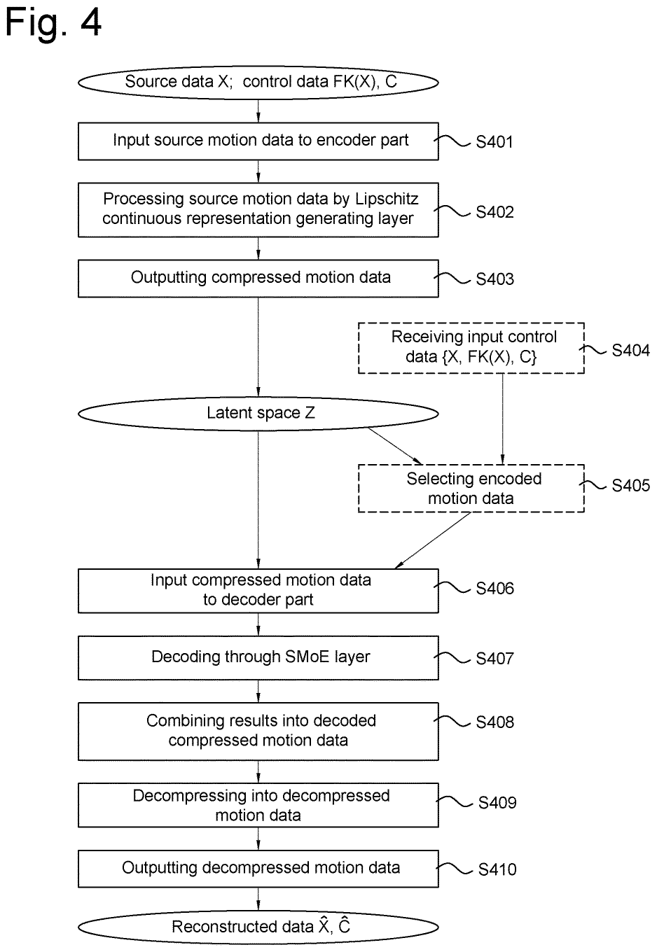

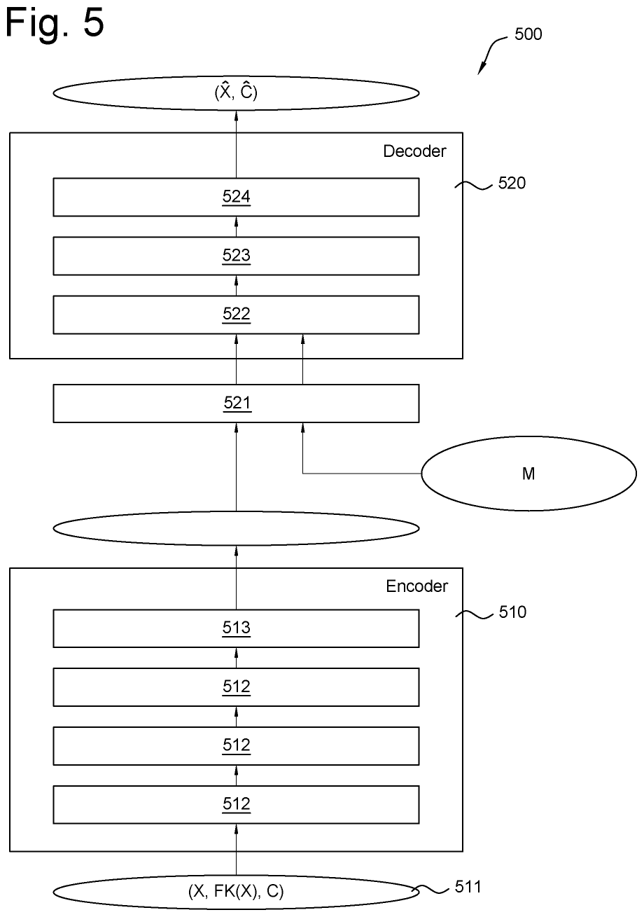

FIG. 4 shows a flowchart of a method of interactive motion data processing using a neural network data coding model, according to another nonlimiting example. A neural network data coding model, which may be used in the method of FIG. 4, is schematically illustrated in FIG. 5. A detail of the decoder part used in FIG. 4 is schematically shown in FIG. 6.

The steps of the method according to FIG. 4 largely corresponds to the method discussed with respect to FIG. 1, and will therefore, where directly corresponding, not necessarily be discussed in detail again.

The method as schematically shown in FIG. 4 comprises the steps of:

S401: inputting the source motion data into an encoder input layer of the encoder part of the data coding model;

S402: processing the source motion data by at least one Lipschitz continuous representation generating layer, thereby transforming the input motion data into compressed motion data based on a Lipschitz continuous function. In all examples of the present disclosure, the motion data may be encoded through successive transformations by a plurality of Lipschitz continuous representation generating layers.

S405: outputting the compressed motion data by an encoder output layer of the encoder part.

Analogous to the method of FIG. 1, the method may optionally comprise the steps S404 and S405:

S404: receiving input control data.

S405: selecting encoded motion data, in particular an encoded motion data frame, from latent data, e.g., encoded motion data previously generated by the encoder part, based on the input control data.

S406: inputting the compressed motion data into a decoder input layer of the decoder part and directing it, through the decoder input layer, to a subset selected from a plurality of individual component neural networks of a decoding layer configured as a Sparse Mixture of Experts, SMoE, layer.

S407: decoding the compressed motion data by each one of the subset of the plurality of individual component neural networks to generate a plurality of individual decoded compressed motion data, wherein each individual component neural network is connected to the decoder input layer, and combining the plurality of individual decoded compressed motion data into decoded compressed motion data;

Steps S406 and S407 may be performed by a Sparse Mixture of Experts, SMoE, layer, which is discussed in further detail with respect to FIGS. 5 and 6.

S408: decompressing the decoded compressed motion data by a decompressing layer of the decoder part. In all examples of the present disclosure, decompression may be performed through a plurality of successively connected decompressing layers.

S409: outputting the decoded decompressed motion data as output motion data.

FIG. 5 schematically illustrates a neural network data coding model 500, according to an example of the application, which may be applied when performing the method of FIG. 4. The data coding model 500, also referred to as autoencoder, comprises an encoder part 510 and a decoder part 520. The encoder part may be configured to perform steps S403 to S405 and the decoder part may be configured to perform steps S406 to S410 of FIG. 4.

The data coding model 500 comprises, at least, the following layers.

The encoder part 510 comprises at least the following layers.

An encoder input layer 511 configured for receiving the source motion data.

One or more Lipschitz continuous representation generating layers 512 configured to transform the source motion data into compressed motion data based on a Lipschitz continuous function. Preferably, a plurality of successively connected Lipschitz continuous representation generating layers 512 are provided, wherein each layer 512 further comprises an activation function for activating the subsequent layer 512. Each layer 512 may be associated with its own Lipschitz constant c. Further, each of the Lipschitz layers 512, except for the last 513, is provided with an activation function, as described herein above.

While in the illustration of FIG. 5, five Lipschitz layers are shown, this is merely an example. More or less Lipschitz continuous layers 512 may be provided.

An encoder output layer 513 for outputting the compressed motion data. In the illustrated example, the last Lipschitz layer is configured as an output layer.

The decoder part 520 comprises at least the following layers.

A decoder input layer 521 for receiving the compressed motion data.

In some examples, as discussed in the present application, the compressed motion data may be concatenated with additional input control data, for example motion matching features M, before, upon, or after being input to the decoder input layer. Alternatively or additionally, a predicted future motion data frame may be predicted based on the compressed motion data and, optionally, concatenated with additional input control data prior to being input to the decoder input layer.

A decoding layer 522 configured to decode the compressed motion data into decoded compressed motion data, the decoding layer being configured as a Sparse Mixture of Experts layer, SMoE layer. The SMoE layer and architecture is illustrated schematically in FIG. 6. The SMoE layer comprises a plurality of individual component neural networks, of which only a subset is activated for processing a compressed motion data.

A decompressing layer 523 configured to decompress the decoded compressed motion data. Although in the figure two decompressing layers 523, 524 are shown, a different number of successively connected decompressing layers 223 may be provided. These may be configured as linear layers and an activation function, as described herein above.

An output layer 524 configured to output the decompressed decoded motion data as output motion data. In the illustrated example, the last layer 524 may function both as a decompressing layer and an output layer.

As discussed, configuring the encoding layers to provide Lipschitz continuous representations of the input motion data has been seen to be particularly advantageous, and to provide improved characteristics of the encoding. The temporal relationship between successive data frames is maintained, and the linear relationship and coherency between the original space and the compressed space, also referred to as latent manifold, is preserved. With the Lipschitz technique applied to the encoder part, an improved distribution of data frames in the latent manifold has been observed. These effects enable the use of a sparse layer, such as a Sparse Mixture of Experts, SME, layer as the decoding layer of decoder part.

Each of the Lipschitz continuous representation layers 512 may be configured with an associated learnable Lipschitz constant c, the Lipschitz constant c associated with a weight normalization to be used by the Lipschitz continuous representation layer.

The encoder part 510 of the data coding model 500 may be configured to receive an input (X, FK(X), C) of motion data, and encode this into a compressed representation of the motion data, a latent z. Herein, X may represent a pose of a virtual character, or state of an object, in local space, e.g., in the source motion data, FK(X) represents kinematic data related to the pose, typically including components relating to rotation, movement and positions of joints involved in the virtual character or object, and C represents a parameter related to a number of tags or logical markers that accompany the motion data. For example, these may be markers indicating one or more effects associated with the motion data. For example, when a foot step of a virtual character is detected, and/or a secondary effect such as a sound or logical action should be able to be triggered by the motion data processing according to the present disclosure.

The SMoE layer is configured to receive the latent z generated by the encoder part, which may be combined with additional input control data, including motion matching features M. As described herein above, these may have been extracted from training data and/or received with user input for interactively controlling the reproduction of motion, of animation, data on a display device, such as a virtual environment, for example during simulations or game play. The SMoE layer processes the input data, and generates a decoded, but still compressed representation of the motion, or animation, data, which is input to a first of the linear layers. The linear layers process the data to successively decompress this, into a decompressed representation of the motion data, (\hat{X}, Ĉ).

The data input to the neural network data coding model may hence be a concatenation of the pose in local space X, the model space evaluation after applying forward kinematics EK(X) and any applicable tagging, such as foot contacts of the virtual character or an event or effect associated with the motion data.

The output of the data coding model may include a pose prediction in local space C, including root motion velocities, and any probabilities for any associated tagging per pose ê.

The Lipschitz continuous layers are preferably each associated with a Lipschitz constant c, which is used for determining a weight normalization to be used by the Lipschitz continuous layers. That is, the constant c is used to normalize the weight matrix.

The constant c is learned through the training process. During runtime of the trained network model, the constant c remains constant.

By enforcing Lipschitz continuity to the neural network layers, a similarity of a given pair of input data can be maintained in the resulting reconstructed data output from the data coding model.

Some general concepts of the theory behind the Lipschitz layers are now presented. These algorithms can be implemented through different computational methods and programs, as will be understood by the person skilled in the art. It is to be understood that these concepts and definitions may apply to all examples of the present disclosure.

A function ƒ is defined as Lipschitz continuous when the constant c satisfies:

$$( f ( x ) - f ( y ) ) \leq c \cdot ( x - y )$$

As mentioned above, the Lipschitz constant c is learned through the training of the data coding model. The constant is used to normalize the weight matrix W with rows R, for example using a scaling vector created by a function Scale:

$$Scale ( c , W ) = Min ( \frac{softplus ( c )}{Max ( {\sum }_{r = 1}^{R} \vert {W}_{r} \vert , ε )} )$$

$$WeightNormalization ( {W}_{i} ) = {W}_{i} \cdot Scale ( c , W )$$

Herein, softplus is an activation function, as known the field of neural networking. Softplus is an activation on an input floating point value. It enforces an input number's output to be positive, however it is smoothly applied to produce an initially non-linear output up to a threshold input value, where it becomes linear. For example, it may be represented by

$$f ( x ) = log ( 1 + exp ( x ) ) or$$

$$softplus ( x ) = \frac{1}{β} log ( 1 + exp ( β * x ) )$$

The weight normalization may then applied when treating the Lipschitz layer interchangeably with a linear model, with bias b:

$$LipschitzLinear ( X ) = X * WeightNormalization ( W ) + b$$

At runtime, the constant c remains constant, and the normalization of the weight matrices within a model can thus be evaluated as constant when preparing the model.

FIG. 6 shows a schematic illustration of the architecture relating to the SMoE layer 522 and associated layers according to examples of the present disclosure. This architecture may advantageously be applied in the method of FIG. 4 and the data coding model of FIG. 5.

The Sparse Mixture of Experts architecture 600 illustrated in FIG. 6 is preferably applied to the decoder part 520 of the neural network autoencoder 500, e.g. described with reference to FIG. 5. It may also be applied to components of a neural network predictor model, for example including a neural network stepper model and a neural network projector model, as also described in the present disclosure.

A Sparse Mixture of Experts, SMoE, architecture, 600 as applied in various neural network models according to the present disclosures, can be referred to as conceptually replacing one large neural network layer with a plurality of smaller individual neural networks, referred to as experts. In examples, these are represented as feed forward networks, FFNs. As the number of neural network node connections is significantly reduced, the application of a Sparse Mixture of Experts layer 622 leads to a distribution of processing load, in that the processing of the query is passed on to a relatively small subset of the plurality of experts. This leads to a reduced complexity of processing and reduced processing time.

The SMoE architecture 600 comprises a gating layer 621, a SMoE layer 622, and a summation layer 623.

The SMoE layer 622 comprises a plurality of individual component neural networks 622-1, 622-2, . . . , 622-n. These may also be referred to as experts. These can be considered as functionally arranged in parallel. For ease of illustration, in FIG. 6 five individual component neural networks are shown. However, in general, the number may be (much) larger. In an example, there are 128 individual component neural networks provided in the SMoE layer. During training, these may be trained to perform decoding of various latent motion data, such that parameters, such as weights and activation functions, of the different experts are optimized for different input motion data. Thereby, efficient load distribution can be obtained.

The gating layer 621 receives an input x, calculates gate values of each expert, and routes the input x to the best matched experts selected out of the plurality of experts for processing. In the example of FIG. 6, two experts are selected. In an example, two experts are selected out of the 128 that are provided. This number has been observed to provide an acceptable compromise, or tradeoff, between model accuracy and runtime performance. Other numbers may however be possible.

Each expert calculates their respective normalized gate value y2, y4. The final result y outputted from the SMoE layer is computed as weighted sum of the outputs from the selected experts.

When used in the autoencoder, the output y is subsequently processed by the linear layers 224a, 224b, thereby reforming the original pose dimensions, in layer 623.

Some general concepts of the theory behind the Sparse Mixture of Experts, SMoE technique, are now presented. These algorithms can be implemented through different computational methods and programs, as will be understood by the person skilled in the art.

The gate values may be calculated as a probability distribution over the N experts provided in the SMoE layer. The experts having the highest gate values are selected for receiving and processing the input x.

In mathematical terms, the gating layer 621 takes motion data x as input and passes it on to the selected number of experts having the best match, out of a set

$${\{ {E}_{i} ( x ) \}}_{i = 1}^{N}$$

experts.

Gating log its h(x)=LINEAR(x) are calculated by passing the input through a linear layer, and the final gate values are obtained via a softmax operation which results in a probability distribution over the N experts. Herein, y-Linear(x) may be the following expression y=xA^{T}+b Where A and b are learnable parameters (weights). The probability value, or gate value, of each expert i can be expressed as the softmax function:

$${p}_{i} ( x ) = \frac{{e}^{{h ( x )}_{i}}}{{\sum }_{j}^{N} {e}^{{h ( x )}_{j}}}$$

The input x is then passed on to the experts having the highest gate values. In the illustrated example, the input is routed to the top-2 gate values. The final result is computed as a weighted sum of the output of the two selected experts, weighted by their associated normalized gate values:

$$y = \frac{{p}_{1 st} ( x )}{{p}_{1 st} ( x ) + {p}_{2 nd} ( x )} {E}_{1 st} ( x ) + \frac{{p}_{2 nd} ( x )}{{p}_{1 st} ( x ) + {p}_{2 nd} ( x )} {E}_{2 nd} ( x )$$

Herein, indices 1st and 2nd refer to the indices of, respectively, the highest and the second highest gate values calculated for each one of the plurality of experts according to the probability equation above.

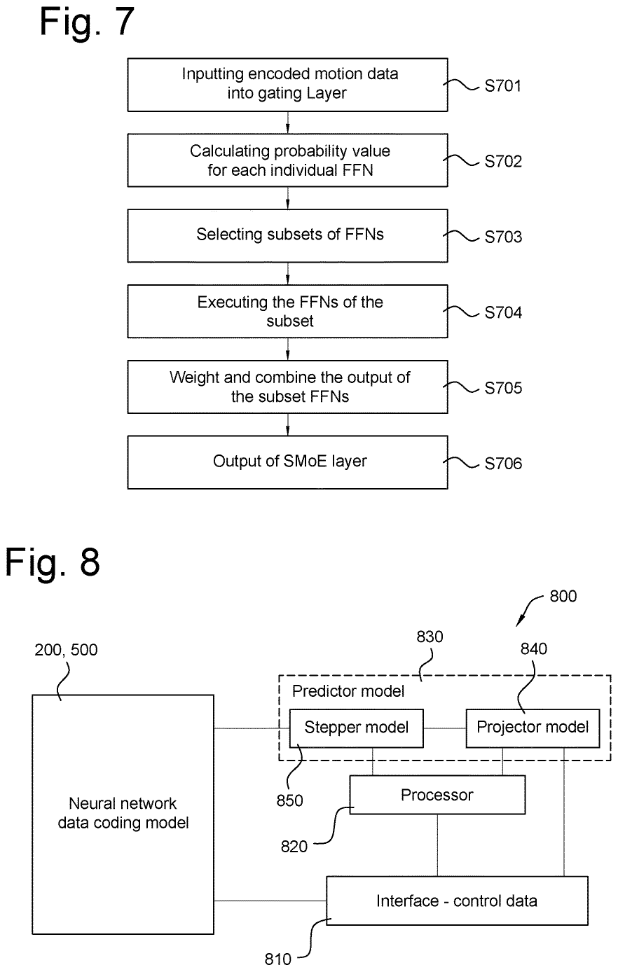

FIG. 7 shows a flowchart illustrating a method performed by the SMoE architecture 600 of FIG. 6, according to examples of the present disclosure. This method may be applied to all examples of the present disclosure where an SMoE layer is used. It may be applied not only in the neural network data coding model, but also in the neural network stepper model and neural network projector model, which may together form a predictor model. With respect to FIG. 7, the method is described as applied in the decoder part 520, 620 of the data coding model. SMoE layers included in the stepper model and the projector model may function in an analogous way. These steps may be performed based on the mathematical concepts set out herein above in respect of the SMoE technique.

In step S701, the compressed motion data, also referred to as latent, is inputted to the gating layer 310.

In step S702, the gating layer calculates the gating values, or probabilities, for each one of the individual experts, with which the respect experts would process the data, and in S703 selects the experts having the highest gating values. That is, the decoder executes the latent as a query to find weights and indices of a subset of individual component neural networks of the SMoE layer to which the input should be forwarded. For example, the subset may comprise two individual component neural networks.

In step S704, the input is processed by the selected experts, That is, the components are executed.

In step S705, the output of the selected experts is weighted respectively. The network calculates a weighted sum of the outputs of the individual component neural networks of the subset and providing weighted sum as output of the SMoE layer. The output of the SMoE layer hence represents the weighted sum of the output of each the individual component neural network of the subset weighted by their associated normalized gate values.

FIG. 8 schematically illustrates a system for interactive motion data processing 800.

The system 800 comprises a neural network data coding model for processing motion data, e.g. a data coding model 200, 500 as described with respect to FIG. 2 or FIG. 5. The system further comprises an interface 810 for receiving input control data, for example user input data, and a processor 820 configured to control the data coding model, e.g. to operate according to a method as described with reference to FIGS. 1-3 or FIGS. 4-6. Optionally, the system may further comprise a neural network predictor model 830, configured to compute predicted future motion data frames based on the latent data generated by the encoder part of the neural network data coding model, user input data, and motion matching features, and input this as a future representation of the latent motion data into the decoder part of the data coding model. The motion matching features may have been determined during training of the neural network, and/or be standard motion matching features otherwise predetermined, and may be stored in a database. The predictor model 830 may comprise a stepper model 850, configured to predict future motion data frames at a future time, through applying the motion matching features in successive steps in time. The projector model 840 may be configured to project the input control data to the latent space, to select, or retrieve, a motion data frame, e.g. comprising a character pose and associated features, having a closest match with the input control data, e.g. the intentions of the user as represented or deducted from the input control data.

In FIG. 9, a method of processing motion data in real time, using a system or models according to examples of the application is schematically illustrated. For example, the method of FIG. 9 may be performed by the system described with reference to FIG. 8. For illustration, the method is described herein below in relation to game play. However, it should be understood that the system and method may be applied to other applications of real time controlled motion data processing involving a prediction of future motion data frames based on user input.

The method may be performed using a system as shown in FIG. 8, wherein the predictor model 830 comprises a neural network stepper model 850 and a neural network projector model 840.

In steps 910-a to 910-e, the user, through his user input control data, queries a suitable motion data for a desired movement. In other words, the user inputs input control data to the system, indicating desired movements and/or actions to be performed or applied to a virtual character or other object in a virtual environment visually reproduced to the user and which the user wishes to control. Hence, with this method, the user may, continuously, interact with the virtual environment and trigger various actions and events therein.

910-a. The motion data processing system, in particular the neural network projector model, is executed with the query representing user's input control data. In some examples, the projector model comprises an SMoE architecture similar to the one described with reference to FIG. 6.

910-b. The query is converted to an additional weight for a subset of components in the SMoE layer of the neural network projector to execute.

910-c. Each individual neural network layer of the subset components executes on the query.

910-d. The two results are multiplied by the weights and combined.

910-e. The resulting output, which is selected from the compressed motion data, or “latent”, as the motion data frame best matching with the query, which may have been previously generated as an output of the encoder part of the data coding model, is passed on to the stepper model.

The neural network stepper model 830 is configured to perform the steps involved when the “latent”, output by the encoder part, is used to find the resulting motion data some time X seconds in the future.

920-a. The prediction is autoregressively called some number of steps until time X is reached in the stepper model. is the stepper model preferably has an architecture similar to the projector model executing the steps 910a-910e.

920-b. For any remaining time less than a whole frame, the result can be interpolated.

920-c. The resulting prediction is outputted, and may be passed onto the decoder part for reconstructing the motion data and blending it into data in the virtual environment.

The decoder part 520 of the data coding model 500 performs the steps involved when the “latent”, as determined by the projector and stepper, is passed to the decoder part of the data coding model for a final frame of motion data in a virtual environment, for example a final animation in-game, e.g., an animation frame in the point in the future.

930-a. The decoder executes the latent as a query to find weights and indices of a subset, e.g. two, of individual neural network components of the SMoE layer.

930-b. Both components are executed.

930-c. Their output is weighted respectively.

930-d. The combined result is returned to the user.

940. A frame of animation can now be played on any given character for whom the data was authored.

Prior to use during runtime, e.g., prior to use in interactively performing motion data processing as described in the above examples, the neural network models described herein are trained, for example using backpropagation techniques as known in the field of neural networks. The model is hence trained, to learn the model to encode and decode source motion data into reconstructed motion data. During training, the weights of the individual layers thereof are determined, and optimized.

FIG. 10 shows a non-limiting example of a method for constructing the neural network data coding model according to the examples of the present disclosure. The neural network data coding models 200, 500 as described herein above with reference to FIG. 2 and FIG. 5, respectively, may be generated by this method.

In step S1001, the encoder part is initialized by successively connecting a plurality of encoder layers:
an encoder input layer for receiving source motion data;
at least one continuous representation generating layer configured to transform the source motion data into compressed motion data based on a predefined continuous function;
an encoder output layer for outputting the compressed motion data;

In step S1002, the decoder part is initialized by successively connecting a plurality of decoder layers:
a decoder input layer for receiving the compressed motion data;
a decoding layer configured to decode the compressed motion data into decoded compressed motion data, the decoding layer comprising a plurality of individual component neural networks each connected to the decoder input layer to receive the compressed motion data providing as output decoded compressed motion data;
a decompressing layer configured to decompress the decoded compressed motion data, and
an output layer configured to output the decompressed decoded motion data as output motion data;

In step S1003, the neural network data coding model is trained until a matching between source motion data input into the data coding model and a resulting output motion data, representing the source motion data as processed by the data coding model, meets a preset quality level.

In step S1001, the at least one continuous representation generating layer may be configured as a Lipschitz continuous representation layer, configured to transform the source motion data using a Lipschitz continuous transformation, to form a Lipschitz continuous representation of the motion data. Each of the Lipschitz continuous representation layer may be formed by constructing a linear layer with an associated learnable Lipschitz constant c, and using the Lipschitz constant c for determining a weight normalization to be used by the Lipschitz continuous representation layer.

In step S1002, the decoding layer may be configured as a Sparse Mixture of Experts, SMoE, layer. The related architecture and function of such layer has been described herein above with reference to FIG. 6.

Details relating to training of the neural network data coding model will now be described.

During training of the neural network data coding model, Source motion data (X, FK(X), C) is input into the encoder, e.g., to the first one of the Lipschitz continuous layers. The motion data is passed through and processed by the successive layers of the data coding model, and reconstructed motion data (\hat{X}, Ĉ) is output. The reconstructed motion data is compared with the source motion data, and a matching between the reconstructed motion data and the source motion data is assessed, or determined, and from this assessment a quality level of the reconstructed motion data is determined. This can be performed in various manners, as are known in the art.

The training is iterated until the quality of the reconstructed motion data meets a preset quality level. In other words, the training is iterated until a loss is minimized. The loss can be calculated using loss functions known in the art.

With the different iterations, the internal “weights” of the layers of individual layers in the neural network models may be updated using a standard deep learning process, e.g. involving backpropagation for calculating the gradient of a cost function, which is minimized with respect to the trainable, or learnable, internal weights of the model. The gradient is subsequently input to a minimization algorithm. Various algorithms as known in the art may be used, for example, stochastics, gradient descent, Adan, Adam, etc., which uses the current gradient plus additional information, including the learning rate, to update the weights. Additional information can be a weighted average of past gradients/solutions for example.

The methods for updating the weights, and the criteria for updating these may be set according to principles known in the art. These losses numerically state how well or badly a particular iteration performed or a subset of the entire source training data.

The training of the neural network model may be run, or re-iterated for a minimum number of steps, which may be set based on testing to iterate long enough to ensure that the positions of individual features of a virtual character or object present in motion data frames, for example bones in a character's pose, have a mean positional error that is less than a predetermined value. For example, in applications involving virtual characters, the predetermined value may be set as to when the bones in the character's pose are reconstructed with an accuracy of 1 cm or less. This predetermined value may represent a primary metric to express final quality for an end user.

One or more of the training steps, such as calculations and/or evaluation of the matching between the source motion data and the motion data output by the neural network data coding model during training, e.g., the reconstructed motion, or pose, data, may be performed by the same or by a different processor as the processor on which the encoding and/or decoding steps are performed.

The neural network is trained to reconstruct the input motion data, which may for example include a pose, by first compressing to the latent representation z, then “decoding” the compressed representation to reconstruct the original pose from the latent representation, and then assessed how closely it matches. Neural network training runs until such a time as the quality meets an acceptable metric to present desirable quality level when used in a video game.

The neural network autoencoder model may be trained in pairs of temporally consecutive motion data frame, e.g., representing temporally consecutive poses.

When training the autoencoder in pairs of temporally consecutive poses, an additional loss for minimizing the difference between local space and model space velocities in the training data and predictions can be expressed in various ways.

For example, it may be expressed as:

$$VelocityLoss ( P , \hat{P} ) = \frac{1}{J} {\sum }_{j = 1}^{T} ( \frac{{P}_{1} - {P}_{0}}{δ t} - \frac{\hat{{P}_{1}} - \hat{{P}_{0}}}{δ t} )$$

Herein, P₁, P₀ represent two original motion data frames, e.g. including poses, of the source motion data at times t0 and t1. \hat{P}₀, \hat{P}₁ represent the corresponding motion data frames in the output data, e.g., the output of the neural network's reconstruction of the motion data frames, or pose. From this, the velocity observed in the original motion data for a time “t” between t0 and t1 can be calculated. The idea is to minimize the difference between the original motion data and the reconstructed output from the neural network model. The intuition is that encouraging the neural network to learn to produce a similar velocity on parts of the pose to the original data will produce a smoother reconstruction of motion data that better maps to the source motion data.

Thereby, an overall velocity with the predictions of future frames can be evaluated. The training of the neural network may further take into account, in the loss function, an additional loss term for minimizing a difference between local space velocities and model space velocities in the training data and predictions. This may be calculated as a load balancing term to the SMoE layer, for ensuring efficient experts utilization.

In respect of the Lipschitz layers in the encoder, during training, the loss may be calculated as follows. Where N is the number of Lipschitz layers, the cumulative product of each layer's Lipschitz constant c, expressed as softplus (cᵢ), may be calculated. These may subsequently be combined with L1 and L2 metrics, and velocity minimization losses (weighted λ1, λ2, λ3, respectively) on the latent values z produced per batch B to produce a final regularization loss:

$$L 1 Loss ( z ) = {λ}_{1} \cdot {( z )}_{1}$$

$$L 2 Loss ( z ) = {λ}_{2} \cdot {( z )}_{2}^{2}$$

$$LatentVelocityLoss ( z , δ t ) = {λ}_{3} \cdot {( \frac{{z}_{1} - {z}_{0}}{δ t} )}_{1}$$

$$LipschitzLoss = α \cdot {\prod }_{i = 1}^{N} softplus ( {c}_{i} )$$

As concerns the SMoE architecture, during training of the neural network autoencoder model, optionally an auxiliary load balancing loss term may be added, to further improve the load balancing effect.

The following provides an example of such auxiliary load balancing loss term. It should however be understood that other load balancing loss terms may be used.

Given N experts indexed i=1 to N and a batch B with T batch entries, the auxiliary loss can be computed as the scaled dot-product between vectors f and P:

$$LoadBalancingLoss = α \cdot N {\sum }_{i = 1}^{N} {f}_{i} \cdot {P}_{i}$$

Herein, α is the loss relative weight within an overall model cost function, fi is the fraction of batch entries dispatched to expert i, and Pi is the fraction of the gating layer probability allocated for expert i.

The auxiliary loss encourages uniform routing of the batch entries since it is minimized under a uniform distribution when the vectors fi and Pi have values of 1/N.

In some examples, α may be set to 0.01 for all models.

The fraction of batch entries dispatched to each expert, i, may be calculated as

$${f}_{i} = \frac{1}{T} {\sum }_{x ∈ B} 1 \{ arg max {p}_{i} ( x ) = 1 \}$$

The fraction Pi may be calculated as

$$P = \frac{1}{T} {\sum }_{x ∈ B} {p}_{i} ( x )$$

Alternatively, a Soft Constraints' approach may be used, which may be known to the skilled person:

$${ℒ}_{KL} = {w}_{KL} \cdot {D}_{KL} ( P \vert \vert Q ) = {w}_{KL} \cdot {\sum }_{i = 1}^{N} P ( {E}_{i} \vert X ) \cdot ln ( \frac{P ( {E}_{i} \vert X )}{Q ( {E}_{i} )} ) = {w}_{KL} \cdot {\sum }_{i = 1}^{N} \frac{{I}_{i} ( X )}{\vert X \vert} \cdot ln ( \frac{{I}_{i} ( X ) \cdot N}{\vert X \vert} )$$

Herein, I(X)/|X| is the same as Pi in the previously stated equation describing auxiliary load balancing above, fi thereof is no longer required.

It should be noted that these two ways of expression auxiliary load balancing are merely examples of methods aiding with load balancing between experts of an SMoE layer, and that various other functions may be used.

During the training of the neural network models, the neural network models learn to efficiently distribute the input data between a subset of the individual component neural networks for a given query, and then combine the results of the individual component neural networks of the subset.

By training the neural network to learn to specialize the individual component neural networks, e.g., the experts, for solving a particular part of the dataset and encouraging it to distribute this evenly, bounds can be put on how much of the network needs to be executed to synthesize a single sample of data at runtime significantly compared to other methods.

Consequently, the neural networks can overall be smaller, because the method allows smaller components to specialize, a larger model with more redundant components does not need to be used and can be constrained to ensure such redundant memory and CPU usage is not required to enable the neural network to learn a high enough quality of representation compared to other methods.

The neural network stepper model may be autoregressively trained to predict the increments with each step in time in the output from the original value, e.g., to predict a delta value, δz, of the output of the encoder part, latent z, and an output delta of the motion matching features M, δM.

Each step of the stepper increment calculations is equivalent to a time step δt of:

$$δ t = \frac{1}{fps}$$

Where fps represents the number of frames per second.

The training starts at a sampled animation data frame of the concatenated inputs (z₀, M₀) and is then predicted autoregressively on a number, n, of predictions, up to (zₙ, Mₙ).

$$δ {\hat{z}}_{n} , δ {\hat{M}}_{n} = Stepper ( {z}_{n} , {M}_{n} )$$

$${\hat{z}}_{n + 1} = {\hat{z}}_{n} + δ {\hat{z}}_{n}$$

$${\hat{M}}_{n + 1} = {\hat{M}}_{n} + δ {\hat{M}}_{n}$$

Due to the animation data being substantially smooth, data can be sampled in between data frames, in a manner similar to the sampling of the original source animation, e.g., on intervals:

$$δ t < \frac{1}{fps}$$

Losses for the predictions and velocity similarities can be cumulatively gathered over all predictions n. A mean squared error calculated over all losses can be used for estimating the loss. This may be performed by methods as known in the art.

The stepper model and the projector model may be trained, preferably concurrently, after the training of the autoencoder model has been completed. Thereby, the functional interrelationship by the two models can be accurately and efficiently trained.

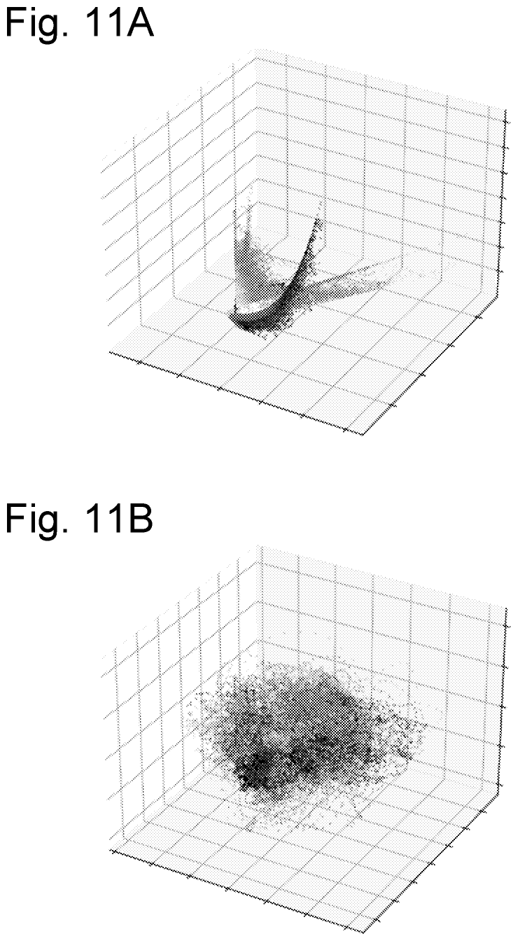

FIGS. 11A, 11B schematically illustrates an advantageous effect as observed using the Lipschitz layers for generating the encoded data as described with respect to FIGS. 4-6 herein above. FIG. 11A illustrates a latent distribution generated using a conventional encoder part, not using Lipschitz transformation, e.g., not using Lipschitz continuous representation generating layers. FIG. 11B illustrates the distribution in a latent space as obtained using the data coding model and system of the present disclosure, e.g., resulting from encoder layers generating Lipschitz continuous representations of the input motion data.

As can be seen, the Lipschitz continuous transformations result in an improved distribution of the latent, e.g. a denser latent space. This is advantageous as it allows predicting future motion data frames with steps smaller than the time scale between consecutive motion data frames, e.g., future motion frames can be predicted with higher accuracy. This increase density in latent space also enables applying the SMoE architecture in the data coding model, the stepper model, and the projector model, according to the present disclosure.

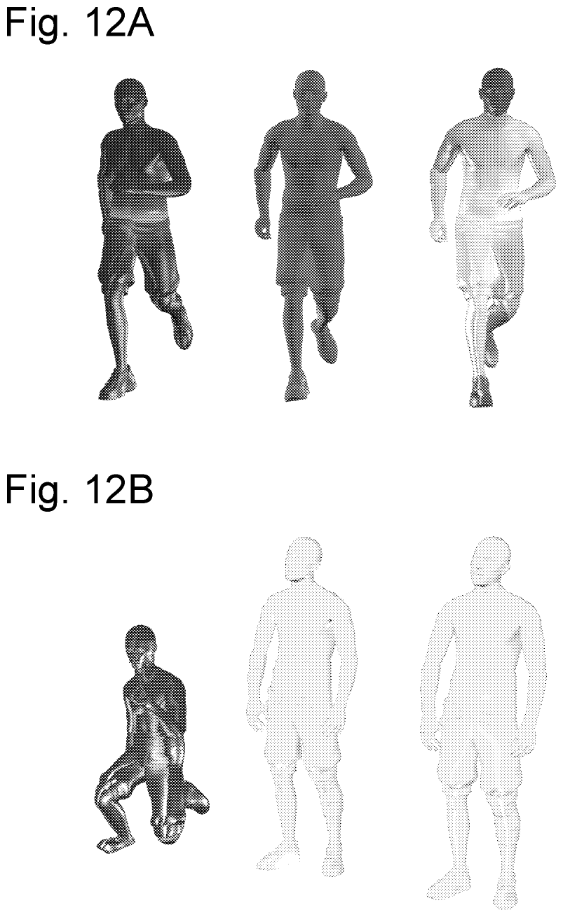

FIGS. 12A, 12B schematically shows improved accuracy of reconstructed motion data, obtained with the present application according to the example described with reference to FIGS. 4-6 and FIGS. 8-9.

In each figure, the center character represents the character pose in the source motion data. The left character represents a character pose as obtained through encoding and decoding using a conventional model, not using Lipschitz continuity and Sparse Mixture of Experts. To the right, the character pose obtained with methods of the present disclosure, e.g., encoding using Lipschitz transformations and decoding using a Sparse Mixture of Experts architecture. The lighter the grey scale color, the closer the reconstructed character is to the source data, e.g., the better the accuracy of the reconstruction.

FIG. 12A represents a currently displayed pose. FIG. 12B shows predictions of a future pose calculated from the motion data frame, or pose data, of FIG. 12A, based on user input data indicating a desired movement of the virtual character.

As can be seen, the method according to the present disclosure provides reconstructed pose data having improved accuracy. This becomes in particularly apparent in the predicted poses shown in FIG. 12B.

Hence, according to the present disclosure, a neural network, also referred to as projector, is used to retrieve samples based on user input and character, for example, desired movement direction sometime in the future that changes from the current direction of movement. An additional neutral network, in the form of an autoencoder, is then used to reconstruct the original animation pose from the compressed sample. A third neural network is used to predict from the compressed samples what continuing to play the animation would do, thereby allowing a user to combine new selections and existing ones together. The internal architecture of these neural network models have been described in the various examples described herein above.

It will be clear to a person skilled in the art that the scope of the application is not limited to the examples discussed in the foregoing, but that amendments and modifications thereof are possible without deviating from the scope of the application as defined in the attached claims. While the application has been illustrated and described in detail in the figures and the description, such illustration and description are to be considered illustrative or exemplary only, and not restrictive. The present application is not limited to the disclosed examples but comprises any combination of the disclosed examples that can come to an advantage.

Variations to the disclosed examples can be understood and effected by a person skilled in the art in practicing the claimed application, from a study of the figures, the description and the attached claims. In the description and claims, the word “comprising” does not exclude other elements, and the indefinite article “a” or “an” does not exclude a plurality. In fact it is to be construed as meaning “at least one”. The mere fact that certain features are recited in mutually different dependent claims does not indicate that a combination of these features cannot be used to advantage. Any reference signs in the claims should not be construed as limiting the scope of the application. Features of the above described examples and aspects can be combined unless their combining results in evident technical conflicts.

1. A method of motion data processing using a neural network data coding model, comprising:
inputting source motion data into an encoder input layer of an encoder;
processing the source motion data by at least one continuous representation generating layer of the encoder, by transforming the source motion data into compressed motion data based on a predefined continuous function;
outputting the compressed motion data by an encoder output layer of the encoder;
inputting the compressed motion data into a decoder input layer of a decoder and directing the compressed motion data, by the decoder input layer, to a plurality of individual component neural networks of a decoding layer;
decoding the compressed motion data by each one of the plurality of individual component neural networks to generate a plurality of individual decoded compressed motion data, wherein each one of the plurality of individual component neural networks is connected to the decoder input layer;
combining the plurality of individual decoded compressed motion data to generate decoded compressed motion data;
decompressing the decoded compressed motion data by a decompressing layer of the decoder; and
outputting the decoded decompressed motion data as output motion data.

2. The method according to claim 1, wherein the predefined continuous function is a Lipschitz continuous function, and wherein each of the continuous representation generating layers is configured as a Lipschitz continuous representation layer with an associated learnable Lipschitz constant c, the Lipschitz constant c associated with a weight normalization to be used by the Lipschitz continuous representation layer.

3. The method according to claim 1, wherein the source motion data is transformed by a plurality of successively connected continuous representation generating layers.

4. The method according to claim 1, wherein the decoding layer is configured as a Sparse Mixture of Experts (SMoE) layer.

5. The method according to claim 4, wherein the decoder input layer is a gating layer, the method further comprising:
inputting the compressed motion data into the gating layer;
calculating, by the gating layer, a probability of activation for each one of the individual component neural networks;
selecting a subset of the plurality of individual component neural networks corresponding to a preset number of individual component neural networks having highest probability of activation among the individual component neural networks;
gating the compressed motion data to the subset of individual component neural networks; and
calculating a weighted sum of outputs of the subset of individual component neural networks and providing the weighted sum as an output of the SMoE layer, wherein the weighted sum represents a sum of the output of each individual component neural network of the subset of individual component neural networks weighted by their associated normalized gate values.

6. The method according to claim 1, further comprising storing the compressed motion data output by the encoder output layer as stored compressed motion data, the compressed motion data comprising a plurality of compressed motion data frames, the method further comprising:
receiving input control data;
selecting one of the plurality of compressed motion data frames from the compressed motion data based on the input control data; and
inputting the selected compressed motion data frame into the decoder input layer, and subsequently performing the directing, decoding, decompressing and outputting steps on the selected motion data frame.

7. The method according to claim 6, wherein the input control data comprises user input control data and information of a virtual object controlled by a user, the user input control data comprising information relating to at least one of:
an action to be performed on or by the virtual object,
a movement to be performed by the virtual object, and
a change in orientation to be performed by the virtual object.

8. The method according to claim 7, further comprising:
predicting a future motion data frame representing the motion data at a future point in time based on the compressed motion data and the user input control data, and inputting the future motion data frame to the encoder input layer.

9. The method according to claim 8, further comprising concatenating the compressed motion data or the future motion data with additional control data and inputting the concatenated data into the decoder input layer.

10. A system for motion data processing, comprising
one or more processors; and
memory storing instructions that, when executed by the one or more processors, cause the system to:
input source motion data into an encoder input layer of an encoder;
process the source motion data by at least one continuous representation generating layer of the encoder, by transforming the source motion data into compressed motion data based on a predefined continuous function;
output the compressed motion data by an encoder output layer of the encoder;
input the compressed motion data into a decoder input layer of a decoder and directing the compressed motion data, by the decoder input layer, to a plurality of individual component neural networks of a decoding layer;
decode the compressed motion data by each one of the plurality of individual component neural networks to generate a plurality of individual decoded compressed motion data, wherein each one of the plurality of individual component neural networks is connected to the decoder input layer;
combine the plurality of individual decoded compressed motion data to generate decoded compressed motion data;
decompress the decoded compressed motion data by a decompressing layer of the decoder; and
output the decoded decompressed motion data as output motion data.

11. The system according to claim 10, wherein the predefined continuous function is a Lipschitz continuous function, and wherein each of the continuous representation generating layers is configured as a Lipschitz continuous representation layer with an associated learnable Lipschitz constant c, the Lipschitz constant c associated with a weight normalization to be used by the Lipschitz continuous representation layer.

12. The system according to claim 10, wherein the source motion data is transformed by a plurality of successively connected continuous representation generating layers.

13. The system according to claim 10, wherein the decoding layer is configured as a Sparse Mixture of Experts (SMoE) layer.

14. The system according to claim 13, wherein the decoder input layer is a gating layer, and the instructions, when executed by the one or more processors, cause the system to:
input the compressed motion data into the gating layer;
calculate, by the gating layer, a probability of activation for each one of the individual component neural networks;
select a subset of the plurality of individual component neural networks corresponding to a preset number of individual component neural networks having highest probability of activation among the individual component neural networks;
gate the compressed motion data to the subset of individual component neural networks; and
calculate a weighted sum of outputs of the subset of individual component neural networks and providing the weighted sum as an output of the SMoE layer, wherein the weighted sum represents a sum of the output of each individual component neural network of the subset of individual component neural networks weighted by their associated normalized gate values.

15. The system according to claim 10, wherein the instructions, when executed by the one or more processors, cause the system to:
store the compressed motion data output by the encoder output layer as stored compressed motion data, the compressed motion data comprising a plurality of compressed motion data frames;
receive input control data;
select one of the plurality of compressed motion data frames from the compressed motion data based on the input control data; and
input the selected compressed motion data frame into the decoder input layer, and subsequently perform the directing, decoding, decompressing and outputting steps on the selected motion data frame.

16. The system according to claim 15, wherein the input control data comprises user input control data and information of a virtual object controlled by a user, the user input control data comprising information relating to at least one of:
an action to be performed on or by the virtual object,
a movement to be performed by the virtual object, and
a change in orientation to be performed by the virtual object.

17. The system according to claim 16, wherein the instructions, when executed by the one or more processors, cause the system to:
predict a future motion data frame representing the motion data at a future point in time based on the compressed motion data and the user input control data, and input the future motion data frame to the encoder input layer.

18. The system according to claim 17, wherein the instructions, when executed by the one or more processors, cause the system to:
concatenate the compressed motion data or the future motion data with additional control data and inputting the concatenated data into the decoder input layer.

19. A method of generating a neural network data coding model for processing motion data, the data coding model comprising an encoder and a decoder, the method comprising:
initializing the encoder by successively connecting a plurality of encoder layers, the encoder layers comprising:
an encoder input layer for receiving source motion data;
at least one continuous representation generating layer configured to transform the source motion data into compressed motion data based on a predefined continuous function; and
an encoder output layer for outputting the compressed motion data;
initializing the decoder by successively connecting a plurality of decoder layers, the decoder layers comprising:
a decoder input layer for receiving the compressed motion data;
a decoding layer configured to decode the compressed motion data into decoded compressed motion data, the decoding layer comprising a plurality of individual component neural networks each connected to the decoder input layer to receive the compressed motion data providing as output decoded compressed motion data; and
a decompressing layer configured to decompress the decoded compressed motion data, and
an output layer configured to output the decompressed decoded motion data as output motion data; and
training the neural network data coding model until a matching between source motion data input into the data coding model and the output motion data meets a preset quality level.

20. The method according to claim 19, wherein the at least one continuous representation generating layer is configured as a Lipschitz continuous representation layer, configured to transform the source motion data using a Lipschitz continuous transformation, to form a Lipschitz continuous representation of the motion data.
